(19) United States
(12) Patent Application Publication
(10) Pub. No.: US 2005/0238340 A1
(43) Pub. Date: Oct. 27, 2005

(54) Radiation heating device for room space

(76) Inventor: Helmut Reichelt, Reichstadt (DE)

Correspondence Address: MCNAIR LAW FIRM, PA, P.O. BOX 10827, GREENVILLE, SC, 29603-0827, US

(21) Appl. No.: 11/144,285

(22) Filed: Jun. 3, 2005

(30) Foreign Application Priority Data
Dec. 5, 2002 (DE) 202 18 886.8
Nov. 24, 2003 (WO) PCT/EP03/13190

(51) Int. Cl. H05B 3/20

(52) U.S. Cl. 392/437

(57) ABSTRACT

A heating device for heating a medium such as a human occupant within an interior room space is disclosed comprising a radiation unit for emitting infrared radiation into the room space. The radiation unit includes a construction board for constructing an interior component within the room space having a planar carrier with a visible exterior face and a planar radiator carried by the planar carrier. The planar radiator operates at one of a selected frequency and a selected frequency band corresponding to a natural frequency band of the medium being heated for resonance heating. A frequency generator excites the planar radiator to generate the desired infrared radiation for heating. The planar radiator is disposed adjacent a back surface of the construction board opposite the exterior facing of the construction board.

### FIELD OF THE INVENTION

This invention relates to a heating device for heating a medium or an occupant in an interior space.

### BACKGROUND OF THE INVENTION

A known generic heating device for heating a medium and/or a human occupant located in a room (WO 00/25552) comprises an emission unit and a frequency generator. The emission unit consists of a planar radiator with a planar carrier and a radiation coating of the type which emits at least a specific frequency of an electromagnetic infrared radiation and/or of frequency-selective electromagnetic oscillation bands in the range of molecular natural frequencies. The planar radiator is connected with a frequency generator such as a harmonic generator through which excitation and activation of the radiation coating generate infrared radiation. The composition of a suitable coating material, as well as the activation of the radiation coating to the frequency generator and its structure are indicated in this state of the art.

The heating effect of this heating device is achieved by exciting the radiation coating so that frequency-selective electromagnetic radiation is emitted. Radiation is produced which is suitable, by means of resonance excitations, to effectively excite corresponding molecular natural frequencies, in particular natural frequency bands of the medium or the occupant being heating. Thus, essentially only such radiation is generated and emitted by the emission unit which is directly utilizable for resonance heating so that very effective heating with little primary energy is possible. The frequency-continuous radiation generated with the common radiation heating installations, especially with electrical resistance heating installations, is essentially equivalent to the radiation spectrum of a black radiator. In accordance to the present invention, a continuous radiation spectrum is generated with the application of relatively high primary energy containing a plurality of frequencies which are not directly utilizable for the resonance heating of a medium or a occupant, if the medium or the occupant is lacking the corresponding molecular natural frequencies.

Accordingly, an object of the invention is to further develop such a heating device in terms of its practical utilization and its possibilities for application in the interior finishing of construction and in recreation areas.

### SUMMARY OF THE INVENTION

According to the present invention, a heating apparatus including an emission unit in the form of a construction board for an interior finishing component, such as for cabinet making, and/or ceiling, wall, or floor construction is provided wherein a planar radiator having a radiation coating is integrated into the construction board.

One or even several combinable emission units are available as independent construction boards which can be conveniently handled and mounted. In particular, it has been shown that it is largely uncritical and does not, or only negligibly, influence the efficiency of the frequency-selective infrared radiation if the radiation coating area is covered by a solid planar carrier toward the visible front side and the room's interior side. For such a cover, wood and laminate materials are, inter alia, excellently suited so that solid construction boards with attractive visible surfaces can be manufactured.

Such construction boards which can be manufactured as wall boards, ceiling boards or floor boards utilizable for the corresponding manufacture of a wall heating, a ceiling heating or a floor heating system. The construction boards cannot only be distributed and mounted by craft businesses, but also can be offered via home builders' markets for do-it-yourself users. Moreover, such construction boards can be manufactured in the type of door leaves or panels so that otherwise unused door areas can be utilized for heating purposes.

To this end, the planar radiator can be mounted on the rear surface of the construction board or within the board thickness of the construction board. In this case, depending on the case of application and the carrier material, the radiation coating can be directly applied on the planar carrier. The radiation coating is applied, if necessary, on a film layer, which will then be connected with the planar carrier for the manufacture of the planar radiator.

An efficiency increase of the heating device can be achieved, if necessary, by a multi-layer design of the planar radiator, wherein this is formed by at least two radiation coatings which are insulated from each other, if necessary, in connection with film layers.

Conventional electrically insulating construction board materials can be used as planar carriers. Particularly preferred as planar carrier fixing boards is the use of MDF boards (mean density fiber boards) and solid wooden boards, as well as glass plates. Moreover, composite boards can be used.

The frequency generator may be coupled with a control unit so that the frequency-selective emitted radiation frequency or radiation band is adjustable to at least one molecular natural frequency or natural frequency band of the medium or the occupant to be heated.

If a suitable detection unit is available for the detection of the natural frequencies or natural frequency bands emitted by the medium or the occupant to be heated, the detector signal can be used as the actual value for an adjustment of one or several corresponding emission frequencies.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a block diagram of the heating device according to the invention; and

FIG. 2 is a section through a construction board along line II-II in FIG. 1.

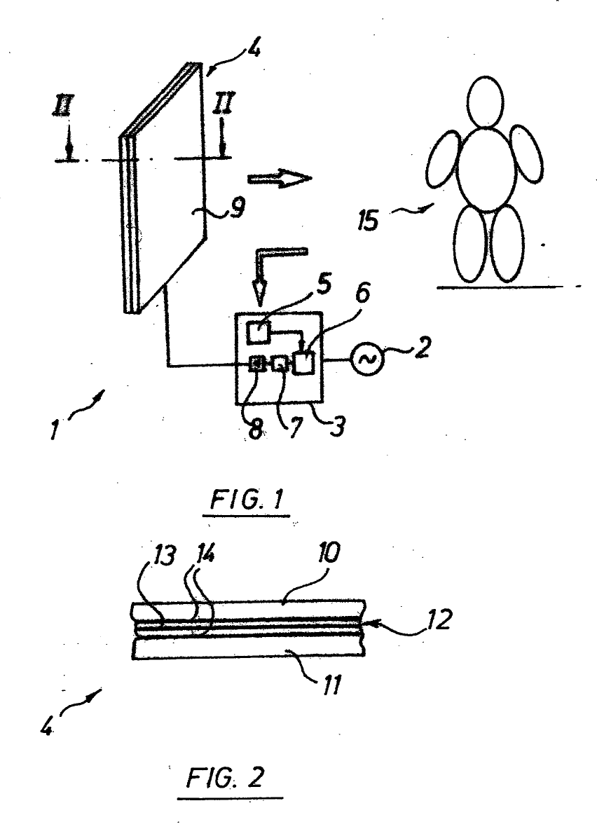

### DETAILED DESCRIPTION OF AN EMBODIMENT

A heating device, designated generally as 1, is illustrated according to the invention which includes a signal processing unit 3 connected to a voltage source 2, and a emission unit, designated generally as 4, electrically connected with the processing unit. Signal processing unit 3 includes a detection unit 5 for detecting the natural frequency bands suitable for the resonance heating of the medium or occupant, a control unit 6 for controlling the unit, a frequency generator 7, and an amplifier 8.

Emission unit 4 may advantageously be a construction board 9 such as a board-shaped furniture part 9 which can form, for example, a wall or a door of a cabinet. The furniture part 9 is designed as a multi-layer MDF board. As can best be seen from FIG. 2, construction board 9 consists of a top layer 10, a bottom layer 11 providing a planar carrier, and of a middle layer, designated generally as 12, is sandwiched between top and bottom layers 10 and 11. Top and bottom layer 10, 11 are made of wooden materials. Middle layer 12 is designed as a planar radiator which emits desired infrared radiation including one of a selected frequency and a selected frequency band which is included in the molecular natural frequency band of the medium or occupant being heated. Middle layer 12 includes two planar radiators 14 separated by a continuous insulation layer 13.

Preferably, planar radiators 14 include film layers coated with the radiation coating in electrical connection with signal processing unit 3. Planar radiators 14 are each structured such that by means of an activation by the frequency generator 7 and a frequency transformation in the radiation coating, the aforementioned selected frequency emission in the infrared range is generated. The radiation frequency is adjustable to the natural frequencies within the frequency bands for resonant heating of occupant 15, illustrated here a human occupant. These natural frequencies and frequency bands of occupant 15 are detected by the detection unit 5 and transmitted to the control unit 6. The control unit 6 controls frequency generator 7 such that by means of its excitation, a frequency and frequency band suitable for resonance heating is emitted from the emission unit. Moreover, the amplitude and thus the caloric output is adjustable via an amplifier 8.

For this purpose, control unit 6 can be connected with an input and display unit (not shown) by means of which a user from the outside can adjust the degree of heating.

Since the natural frequency of the medium or, respectively, the occupant to be heated lies in a range from 750 nm to 20 μm, the emitted frequency range has no adverse health effects.

While a preferred embodiment of the invention has been described using specific terms, such description is for illustrative purposes only, and it is to be understood that changes and variations may be made without departing from the spirit or scope of the following claims.

1. A heating device for heating a medium such as a human occupant in an interior room space comprising:
an emission unit for radiating heat into said room space having a planar radiator for emitting a desired infrared radiation selected from one of a desired frequency and a frequency band included in a molecular natural frequency band of the medium being heated so that the medium is heated by resonance excitation of the medium;
said planar radiator including a construction board for constructing an interior component within the room space;
said construction board having a pair of planar carriers and a planar radiator carried between said planar carriers as a selective radiator; and
a frequency generator operatively connected with said planar radiator for exciting said planar radiator to generate said desired infrared radiation.

2. A heating device of claim 1 wherein said planar radiator is disposed adjacent a back surface of said construction board opposite a visible facing side of said construction board.

3. A heating device of claim 2 wherein said planar radiator is formed by at least one film layer having a radiation coating.

4. A heating device of claim 3 wherein said planar radiator includes a plurality of said coated film layers within an insulation layer between said film layers.

5. A heating device of claim 2 wherein said construction board includes one of a wall board for a wall heating installation, a ceiling board, a ceiling panel to produce a ceiling heating installation, a floor board to produce a floor heating installation, a cabinet board component of a cabinet, and a door leaf of a door.

6. A heating device of claim 2 wherein said planar carrier includes one of a particle board, a MDF board, and a solid wood board.

7. A heating device of claim 2 wherein said construction board includes a glass planar carrier.

8. A heating device of claim 2 wherein said construction board includes a multi-layer board in the type of a composite board.

9. A heating device of claim 1 including a control unit coupled with said frequency generator for controlling said frequency generator to generate said desired radiation.

10. A heating device of claim 9 including a detection unit operatively connected to said control unit, said detection unit detecting one of a natural molecular frequency and natural frequency band of the medium to be heated for determining said desired infrared radiation.

11. A heating device for heating a medium such as a human occupant within an interior room space comprising:
a radiation unit for emitting desired infrared radiation into said room space which includes one of a frequency and frequency band corresponding to a molecular natural frequency band of the medium being heated;
said radiation unit including a construction board for constructing an interior component within the room space;
said construction board having a planar carrier with a visible exterior face and a planar radiator carried by said planar carrier to provide a selective radiator generating said desired radiation so that the medium is heated by resonance excitation of the medium; and
a frequency generator operatively connected with said planar radiator for exciting said planar radiator for generating said desired infrared radiation for heating.

12. A heating device of claim 11 wherein said planar radiator is disposed adjacent a back surface of said construction board opposite said exterior facing of said construction board.

13. A heating device of claim 12 wherein said planar radiator is formed by at least one film layer having a radiation coating.

14. A heating device of claim 13 wherein said planar radiator includes a plurality of said coated film layers within an insulation layer between said film layers.

15. A heating device of claim 11 wherein said construction board includes one of a wall board for a wall heating installation, a ceiling board, a ceiling panel to produce a ceiling heating installation, a floor board to produce a floor heating installation, a cabinet board component of a cabinet, and a door leaf of a door.

16. A heating device of claim 15 wherein said planar carrier includes one of a particle board, a MDF board, a solid wood board, and a glass carrier.

17. A heating device of claim 11 including a control unit coupled with said frequency generator for controlling said frequency generator to generate said desired radiation for heating said medium.

18. A heating device of claim 17 including a detection unit operatively connected to said control unit, said detection unit detecting one of a natural frequency and natural frequency band of the medium to determine said desired radiation.

19. A heating device for heating a medium such as a human occupant in a room space having an emission unit with a planar radiator for emitting desired infrared radiation which includes one of a selected frequency and a frequency band generally within a prescribed frequency band corresponding to the molecular natural frequency band of the medium being heated so that the medium is effectively heated by resonance excitation of the medium; said planar radiator including a planar carrier and a radiation coating carried by said planar carrier as a selective radiator; and a frequency generator operatively connected with said planar radiator for exciting said radiator to emit said infrared radiation, wherein said device comprises;
a planar radiator including a construction radiator board for the construction of an interior component of the room space having an exterior carrier board with an exterior face exposed to said room space; and
a radiation coating integrated within said construction board on a side of said carrier board opposite said exterior face so that said construction radiator board radiates said desired infrared radiation.

20. A heating device of claim 19 wherein said planar radiator is disposed adjacent a back surface of said construction board opposite a visible facing side of said construction board, said planar radiator is formed by at least one film layer having a radiation coating.

21. A heating device of claim 20 wherein said planar radiator includes a plurality of said coated film layers within an insulation layer between said film layers.

22. A heating device of claim 21 wherein said construction board includes one of a wall board for a wall heating installation, a ceiling board, a ceiling panel to produce a ceiling heating installation, a floor board to produce a floor heating installation, a cabinet board component of a cabinet, and a door leaf of a door.

23. A heating device of claim 19 including a control unit coupled with said frequency generator for controlling said frequency generator to generate said desired infrared radiation for heating the medium.

24. A heating device of claim 23 including a detection unit operatively connected to said control unit, said detection unit detecting one of a natural frequency and natural frequency band of the medium to be heated for determining said desired radiation.
